(19) United States
(12) Patent Application Publication
(10) Pub. No.: US 2024/0337522 A1
(43) Pub. Date: Oct. 10, 2024

(54) IN-MOTION WEIGHING SYSTEM FOR MOTOR VEHICLES BASED ON RIGID AND FIBER OPTIC SENSORS

(71) Applicant: VELSIS SISTEMAS E TECNOLOGIA VIARIA S.A., Curitiba (BR)

(72) Inventors: Fávero Guilherme SANTOS, Curitiba (BR); Emerson John VIEIRA DA SILVA, Curitiba (BR); Fernando Kelvin DA SILVA SOARES, Curitiba (BR); Guilherme DUTRA, Curitiba (BR); Felipe Luis Caravieri, Curitiba (BR)

(21) Appl. No.: 18/292,872

(22) PCT Filed: Jul. 28, 2022
(86) PCT No.: PCT/BR2022/050296

§ 371 Date: Jan. 26, 2024

(30) Foreign Application Priority Data
Jul. 29, 2021 (BR) 1020210150114

(51) Int. Cl. G01G 19/02; E01F 11/00; G01G 3/12; G01L 1/24

(52) U.S. Cl. CPC G01G 19/022; E01F 11/00; G01G 3/125; G01L 1/246

(57) ABSTRACT

The present invention relates to a weigh-in-motion system for motor vehicles based on a set consisting of loop sensors and fiber optic sensors mounted on a rigid metal profile. Its technical field of application corresponds to systems for measuring dynamic physical events that are caused directly or indirectly by the passage of a motor vehicle over its sensors. The rigid weighing sensor is made of rigid or semi-rigid metal, plastic, composite or similar material, with a deformation profile optimized for transforming vertical stresses into horizontal stresses and containing damping and protection material to attenuate external horizontal stresses. This set makes it possible to measure parameters with high precision and in a reliable and simple way, with the advantages of being installed and molded to any floor, of being minimally intrusive, of not suffering electromagnetic interference, of being low cost, of having a long service life, and of having simple manufacturing technology at a lower cost than that demonstrated in the state of the art.

The present invention relates to a weigh-in-motion system for motor vehicles based on a set composed of inductive loop sensors (capable of measuring the speed and presence of vehicles) and fiber optic sensors mounted on a rigid metal profile (capable of measuring the weight of vehicles). Its technical field of application corresponds to that of systems for measuring dynamic physical events that are caused directly or indirectly by the passage of a motor vehicle over its sensors. The aim of the invention is to monitor road traffic variables such as (but not limited to): detecting vehicles, counting wheels, identifying single and/or double wheelsets, measuring speed, measuring weight per wheel, measuring weight per axle, measuring the weight of groups of axles, measuring the total weight of vehicles, measuring road surface mechanical parameters, measuring the pavement wear index and determining the type of pavement on which it is installed. The solution proposed by the present invention has a number of advantages, including: simplified manufacturing process and compact size, high resolution, sensors immune to electromagnetic interference, long service life and the possibility of deployment over long distances and on different types of pavements.

Monitoring traffic parameters is used in the areas of road safety, traffic control, maintenance and infrastructure, diagnosing traffic problems, preventing and predicting traffic incidents, pricing on toll roads and imposing fines in irregular traffic situations, among many other scenarios. The information generated is used by different agents in society, such as government departments responsible for the road sector, regulatory agencies, public safety entities, road concessionaires, private organizations and, in some cases, road users themselves. The constant evolution of road parameter monitoring techniques is relevant and brings benefits to society.

As technical experts in the field of weigh-in-motion know, the movement of a vehicle on the pavement generally causes physical effects which, when monitored, provide information on the vehicle's characteristics. These characteristics are related to the constructive aspects of the vehicle, such as weight, dimensions, number of wheels and axles, among others, and to the use of the vehicle that is moving over the road, including speed, acceleration, load, number of passengers, among others. Currently known methodologies for detecting and measuring physical parameters involving vehicle traffic are magnetic detection, image detection, optical sensor detection, radar detection, vibration detection, deformation detection and temperature detection.

In some cases, a road traffic monitoring system employs a combination of two or more of the methodologies described above to generate as much information as possible, or even to reduce the uncertainties intrinsic to a given technology by combining the data captured.

In order to guarantee the measurement with low uncertainty of a given variable of interest, the most common technique adopted, whatever the technology applied, is to have as many data readings as possible, so as to have a larger sample size and consequently greater precision.

In general, weighing a moving vehicle is performed by measuring the deformations or vibrations exerted on the road surface. The main differences between measurement methodologies for fiber optic-based sensors, whether reported in the literature in the form of patents or technical articles, relate to the types of sensor elements and their encapsulation. The types of sensor elements vary depending on the type of quantity to be measured, such as intensity, frequency and/or phase, or wavelength of the optical wave. The encapsulation, in turn, consists of the protective element and, above all, the mechanical transduction element responsible for transforming and/or amplifying the force components related to the vehicle's weight.

Some patent registrations in the area of traffic monitoring with fiber optic sensors can be found in the patent databases.

In the Australian patent WO2001027569A1 the optical fiber is attached to a substrate, a deflection plate, which deforms as vehicles pass by and the detection of the optical fiber deformation is based on interferometric measurement.

In British patent GB2056672A, the optical fiber is placed next to and across the path along which the vehicle passes.

American patent U.S. Pat. No. 12,376,875 uses a strain gauge device consisting of a fiber optic Fabry Perot interferometer.

In European patent EP20110160916, a flexible plate with fiber optic diffraction networks is used to measure weight.

In American patent U.S. Pat. No. 7,410,764 the optical fiber is installed between rigid and semi-rigid plates to measure pressure through the deformation/bending of the plates.

In American patent U.S. Pat. No. 11,425,392 diffraction networks are connected to a mechanical structure.

In American patent U.S. Pat. No. 10,467,075 sensor is installed on the road with interferometric detection by Rayleigh backscattering.

Patent U.S. Pat. No. 5,260,520 reports the encapsulation of optical fiber by elastomeric material, this being the transduction element. One of the major problems with this type of material is its dependence on temperature, which alters deformation rates. At higher temperatures, such as those found on pavement, the material can saturate before the end of the measurement scale, thus restricting the operating range of the sensor.

American patent U.S. Pat. No. 5,260,520 discloses a device for weighing moving vehicles that is supplied by a plurality of elongated fiber optic sensors defined by an optical fiber embedded in an elastomeric material encapsulation and arranged parallel to each other on the road in the path of the moving vehicles. Each fiber-optic sensor is provided with contact media arranged in a grid that can be selectively altered to have adequate sensitivity for each vehicle weight range. Switch systems are used in conjunction with the fiber optic sensors to provide signals indicating vehicle speed, weight distribution, tire position and wheelbase. The use of an N-shaped switch configuration also provides determination of the number of tires on each axle, and the tire tread on the ground. When the switches in this configuration are made up of optical fibers, the extent of light transmission by the fibers in contact with the vehicle's tires is indicative of the vehicle's weight.

Chinese utility model patent CN200962255 discloses a fiber vehicle detector that includes a light source, fiber optic sensor unit, detector, data acquisition unit and processing unit, with the fiber optic sensor unit comprising two Mach-Zehnder interferometric sensors that include a stainless steel bar and a lighter plastic sheet of standard shape. The bar can detect the road vibration signal while the sheet acts as a reinforcement under the road surface. The beneficial effects are improved sensitivity and blocking of electromagnetic interference on the detector, with no effect from the environment, and improved signal-to-noise ratio by adding the stainless steel bar and lighter plastic sheet to interferometric sensors, where one arm of the sensor is always the reference arm and the other is the signal arm. In addition, the reference arm is immobile and corresponds to the protective enclosure, as is the rejection of the common mode of the differential amplifier in the electronic circuit when the stainless steel bar and the lighter plastic sheet vibrate together.

Romanian patent RO127980 refers to a method for determining the weight of motor vehicles in motion without restricting in any way the traffic of the vehicles to be weighed and to a device that applies the method. The method measures the variation of the optical power transmitted by an optical fiber depending on the variable weight applied, using an optoelectronic device with a single-mode or multiple-mode optical fiber when light radiation is propagated with the infrared spectral gamma wave emitted in a continuous wave regime by a laser diode or an LED, the optical fiber is mounted on a mechanical device that ensures its curvature depending on the weight to be measured. The claimed device comprises a source of radiation in the near-infrared spectrum which can be a laser diode or an LED, said laser diode or LED emitting the infrared radiation through an optical fiber bent under the weight of the motor vehicle to be weighed, the micro-bending of the fiber caused by the weight causing a change in the transmission of the light emitted through the fiber, proportional to the weight of the vehicle on the asphalt.

Brazilian patent PI0106699 describes an equipment whose main purpose is to provide an automated mechanism for the supervision and inspection of traffic lanes intended for the exclusive use of certain types of vehicles (public transport, official vehicles, etc.). Its function is to identify and record, through digitized images, unauthorized vehicles that are traveling on the exclusive lanes. It is characterized by having vehicle detectors that collect data through sensors, allowing the presence of a vehicle to be identified at a given place and time, as well as its characterization in terms of length parameters and optionally, weight, height, speed and other information concerning the detected vehicle. The data captured by the vehicle detector is transmitted electronically to a local computer. The local computer receives the data from the vehicle detectors, the images from the video cameras, processes them and feeds a database with the information received and processed. The local computer is capable of operating simultaneously with several vehicle detectors and video cameras. The equipment that is the subject of PI0106699 is characterized by using a means of communication that allows data to be exchanged between the local computer and the central processing unit. The means of communication corresponds to any commercially used technology that allows the interconnection of computers, such as common telephone lines, fiber optics, private lines, radio transmission, local or remote computer network connections, among others. The equipment covered by PI0106699 is also characterized by having a central processing unit that carries out the final processing of the information collected on the local computer. The processing center has the capacity to simultaneously process information from several local computers, and its size varies from a single computer to several computers and other accessories in a computer network. The end product of the equipment covered by patent PI0106699 is the processing center's real-time remote supervision of vehicles, automatic identification of vehicles, especially those whose characteristics captured by the vehicle detector do not match the standards allowed for traffic (identification of offending vehicles), generation of information for issuing infraction notices (fines) including the digitized image of the vehicle at the place and time of the occurrence, the vehicle's registration data with its license plate identified through the image (by manual typing or automatic recognition when using automatic character recognition tools), the issuance of infraction notices, the generation of data and statistical reports for studies of behavior and use of the monitored region, among other information that can be easily generated by processing and cross-referencing the information obtained.

American patent U.S. Pat. No. 4,560,016 discloses a method and apparatus for measuring the weight of a moving vehicle, where an optical fiber is embedded in a matrix, such as a rubber mat, and a multiplicity of micro-folding attachment devices are distributed along the optical fiber's path. Thus, as the wheels of a vehicle pass over the mat, the force of the wheels causes the micro-folded fasteners to compress together and attenuate the light that is transmitted through the optical fiber. The light transmitted through the optical fiber from a light source at one end of the fiber is received by a light receiver at the other end of the optical fiber. Then, by measuring the amount of light input and the net amount of light output and calibrating the device, the weight of each axle and the weight of the vehicle above that axle can be measured.

Chinese patent CN2924496 discloses a device for dynamic vehicle axle weighing by optical fiber grating, comprising a laser source. The output terminal of the laser source is connected to a first end of the fiber coupler, and a third end of the fiber coupler connected to the fiber grating wavelength module, photoelectric conversion module, data acquisition equipment and industrial PC. The hydraulic pressure sensing element consists of the fiber grid pressure sensing head, hydraulic valve assembly and hydraulic hose. The fiber grid pressure sensing head is made of epoxy polyester to hold the fiber on both sides of the sensing grid in a flexible metal shim, and the shim is connected to the hydraulic valve assembly which is communicated with the hydraulic hose.

The Chinese patent 206618472 discloses a multi-stage fiber optic grating weighing sensor based on a telescopic rod structure comprising the multiple light source sensing box body structure, optical splitter, optical power meter, demodulation light path and telescopic link. Where the internal structure of the box includes: upper weighing plate, support spring, position control hole, clamp, lever post, cantilever beam, telescopic link. The surface is glued respectively and has a fiber grid over the cantilever beam. Weight load causes the cantilever beam to deform, transmitted through the telescopic link, and changes in the demodulation light output energy value allow the weight to be measured by calculation. The design of the sensor is multi-stage, with the addition of load mass and operating conditions respectively entering different levels to be provided with the overload protector. This structure has managed to improve the measurement range by ensuring the resolving power of the sensor's measurements.

Chinese patent CN208254420 discloses a distributed optical fiber equipment for measuring ground deformation, configured on the optical fiber end, aligned with the fixed anchor plate of a plurality of optical fibers at the bottom of the optical fiber end, the fixed anchor plate of the optical fiber being the reference point, to be equipped with sensing fiber hole and temperature measuring optical fiber hole on the optical fiber fixed anchor plate, so that it moves along with the soil body to realize the real-time load measurement through the sensing fiber and the temperature variation so as to realize the temperature compensation correction, the internal deformation that the soil reaches.

The technologies disclosed by currently existing patents, in relation to the technology of the present patent, have limitations, drawbacks and disadvantages of:

In patents WO2001027569A1, EP20110160916, U.S. Pat. Nos. 7,410,764 and 11,425,392 the measurement methodologies use mechanical transducers based on deflection plates to transform the weight force into mechanical deformation of the optical fiber. In general, this type of sensor has large dimensions, is highly intrusive to the pavement, has highly demanding geometry requirements in terms of installation and is also complex to manufacture.

Patents GB2056672A and RO127980 use the measurement of the variation in the luminous intensity of the light that travels through the optical fiber as a measurement method. The intensity variation occurs by throttling the optical fiber by means of a mechanism with the passage of a vehicle over the fiber. This technique is susceptible to fluctuations in the optical source and detection components, as well as cables and connections, and is therefore inaccurate and unusable in metrological systems.

Patent U.S. Pat. No. 10,467,075 reports the use of a distributed acoustic measurement system for monitoring road parameters. This technique is based on measurements of acoustic emissions from vehicles and the interaction of vehicles with the pavement.

Patent U.S. Pat. No. 5,260,520 reports the encapsulation of optical fiber by elastomeric material, this being the transduction element. One of the major problems with this type of material is its dependence on temperature, which alters deformation rates. At higher temperatures, such as those found on pavement, the material can saturate before the end of the measuring range, thus restricting the sensor's operating range.

The CN U.S. Pat. No. 20,096,255 uses a mechanical transducer based on a stainless-steel plate and a polymer bar to detect vibration. This design is highly complex mechanically, highly temperature-dependent and has large dimensions and is therefore highly intrusive on the pavement.

The applicant of the present patent has filed the Brazilian patent BR 102017017613-4 called “System for monitoring dynamic weighing and speed of vehicles on a track” which discloses fiber optic technology in unique assembly configurations with point and quasi-distributed sensors, which allow rapid response, for the measurement of deformation, vibration, temperature and pressure, be encapsulated to enhance sensitivity to the variables of interest, facilitate the installation process and/or protect the sensing optical fiber, use specific materials and can be installed with advanced optical network configurations, with the advantages of lower cost and longer service life compared to others; the sensors can be multiplexed; they have high spatial resolution across the pavement; the manufacturing technology is simple and cheap and transferable in terms of associated costs. The patent presented differs from patent BR 102017017613-4 in three main aspects; the use of a continuous sensor rather than a point and quasi-distributed sensor; the physical effect on which the measurement is based is interferometric, rather than time of flight and measurement of wavelength variation; and finally, it presents a significant evolution in the method of manufacturing and assembling the weight sensor, which reduces costs and increases the yield of the manufacturing batch.

More recently, the applicant for this patent filed the Brazilian patent BR 10 2021 004560 4 “In-motion weighing system for motor vehicles based on flexible and fiber-optic sensors” which disclosed an in-motion weighing system for motor vehicles based on flexible and fiber-optic sensors. The field of application of the patent object is the measurement of dynamic physical events that are caused directly or indirectly by the passage of a motor vehicle over the sensors. This system consists of 5 blocks; the information processing and presentation equipment (5) is connected to the optical emission and detection equipment (2), one or more presence sensors (3), the temperature sensor (4), and one or more weight sensors (1). It offers advantages over other technologies, such as: simplified manufacture and compact size, sensors immune to electromagnetic interference, long service life, and the possibility of installation on different types of pavement. The patent presented differs from BR 2021 004560 4 in two main aspects: the use of Bragg grating (FBG), long-period grating (LPG) or similar sensors that work by reflecting one or more wavelength bands, unlike the interferometric sensors used previously, and the use of sensors with a rigid deformation profile, as opposed to the flexible ones used previously.

“IN-MOTION WEIGHING SYSTEM FOR MOTOR VEHICLES BASED ON RIGID AND FIBER OPTIC SENSORS”, subject of the present patent, was developed to overcome the limitations, inconveniences and disadvantages of existing technologies for dynamic weighing, vehicle type detection, vehicle position detection and monitoring of physical variables on roadways, by means of: inductive loops, optical fiber and optical and rigid sensor built in metallic, plastic, composite or similar rigid material, with an optimized deformation profile and containing damping and protection material, to make it possible to measure the parameters with high precision in a more reliable and simple way, with the advantages of being able to be installed and molded in any pavement, minimally intrusive, low interference, low cost, prolonged useful life, can be multiplexed, and simple manufacturing technology with lower cost compared to that demonstrated in the state of the art.

The sensor in this patent solved the following technical problems in the following way:
A) Current sensors suffer from electromagnetic interference due to their method of operation, with metallic and electrically based components. This is solved by the present invention through sensing elements that are immune to conducted or radiated electromagnetic interference, due to the inherent characteristics of optical fiber, unlike other technologies that work based on metallic conductors.
B) Current sensors need to be installed close to the weighing system due to interference and noise in their transmission. This is solved by the present invention using fiber optic sensors with a low attenuation of less than 0.5 dB/km.
C) Current sensors suffer from attenuation in their signal transmission. Solved by the present invention through wavelength coding of the sensor signals.
D) Current sensors are large and cannot transmit several signals simultaneously. This is solved by the present invention using sensing elements with high multiplexing capacity and small dimensions.
E) Current systems do not have optimized geometries for controlling the strain exerted on the sensor. The present invention solves this problem by using a deformation profile with a changeable geometry, transforming the vertical stress into horizontal stress, making it possible to increase and decrease the ratio between the stresses.

The following figures are attached for a better understanding of this patent:

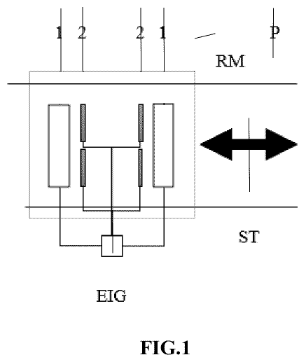

FIG. 1, shows the top view of the installation of the inductive loops, weight sensors and the equipment installed in the cabinet;

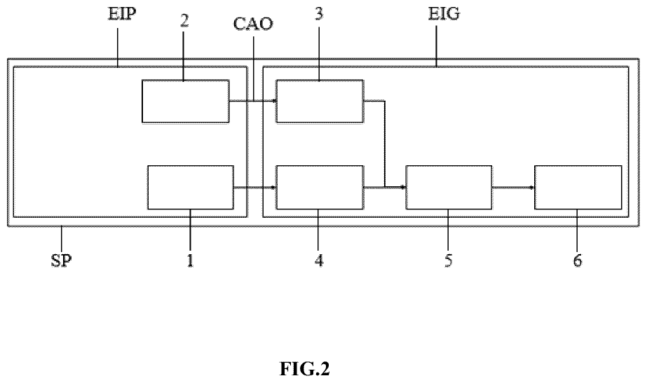

FIG. 2, showing the block diagram of the system in this patent;

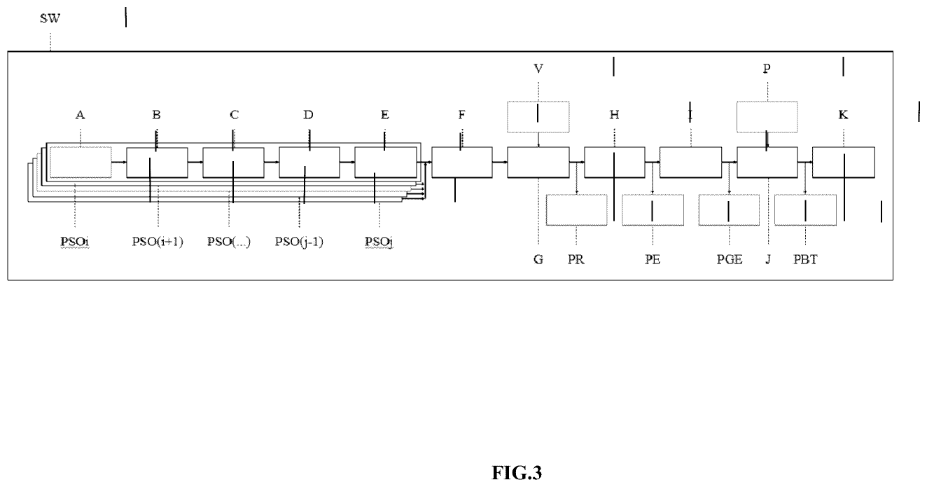

FIG. 3, showing the block diagram of the computer program process carried out by the system of this patent;

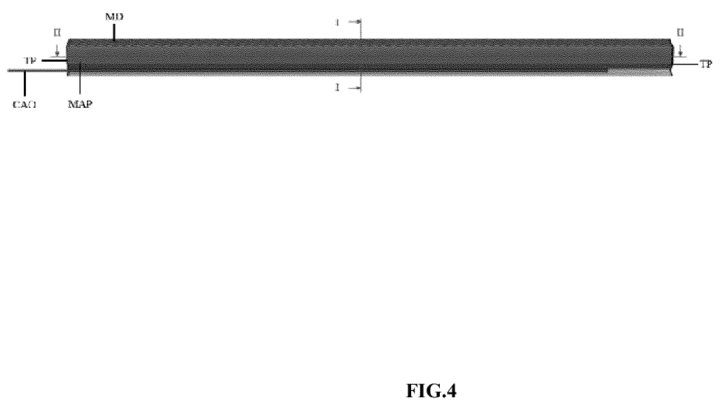

FIG. 4, showing the side view of the weighing sensor of the present patent;

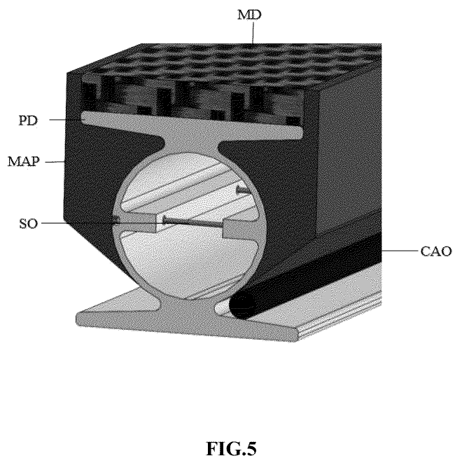

FIG. 5, showing the enlarged front perspective view of the cross-section I-I in FIG. 4, of the weighing sensor of the present patent;

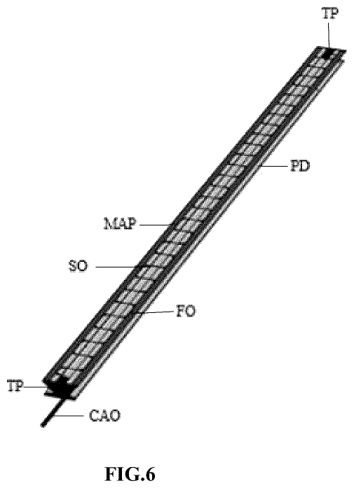

FIG. 6, showing the top perspective view of section II-II in section of FIG. 4, of the weighing sensor of the present patent; and

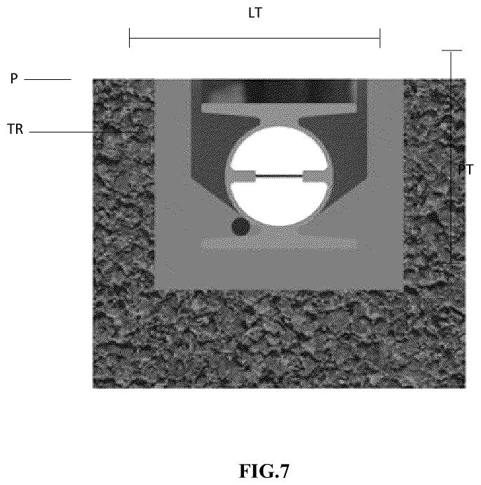

FIG. 7, showing the enlarged front view of the weighing sensor of this patent installed on the floor.

The sensor in this patent also has the following advantages:
Simple production method;
They work by detecting the phase of the optical wave and do not suffer from interference;
Immune to conducted or radiated electromagnetic interference;
No thermal noise between the sensor and the reading unit;
Can be installed at great distances from the weighing system;
Protection against signals being read by third parties;
Immune to reading problems caused by attenuation;
High spatial resolution capacity; and
Sensor sensitivity control.

The system of the present invention was developed based on the inventor's knowledge and experience in his previous technical research and development work with fiber optic sensors and followed the following sequence:

The development began with determining which geometry, material and manufacturing method for the deformation profile would be the most efficient for transforming vertical stresses into horizontal ones. Regarding geometry, it was verified that a circular profile, rather than a triangular, square or oval one, allowed for the uniform transduction of vertical stresses into horizontal ones. Regarding materials, different compositions of steel and aluminum were tested. It was found that 1020 steel with chemical nickel treatment and AL6063 aluminum with T6 treatment are the most suitable materials for the deformation profile, which is manufactured by machining and/or extrusion.

Once the parameters and characteristics of the deformation profile had been defined, it was decided which materials would be used for damping and protection and for roughing. For damping and protection, tests were carried out which identified that the most suitable material to act as a shock absorber was polyurethane rubber, which was initially made of silicone. For the roughing material, which was initially considered to be Celeron, it was changed to a carbon fiber-based composite, since the company applying for this patent has the know-how to manufacture this type of material.

In order to make better use of the weight sensor, it was decided to integrate the optical fiber into the deformation profile, in which several tests were carried out with different glues, concluding that epoxy glue would be the best. In the same weight sensor, it was decided to install FBG, LPG or similar type optical sensors, which work by reflecting one or a band of wavelengths, with the installation distance between the sensors determined by measuring the minimum width of a motorcycle tire.

The research continued at the stage of integrating the entire system and the weighing sensor, with laboratory tests being carried out to validate the weighing concept using a hydraulic press that exerted a vertical force appropriate to the sensor's weighing limits. In parallel with these activities, the development of the computer program began and the algorithms and methods for processing were created, tested and defined, followed by the final stage, which was the field installation of a complete weighing system, the subsequent refinement of the computer program algorithms and making the system available for sale.

According to FIG. 2, the weighing system (SP) is made up of equipment installed on the pavement (EIP) and equipment installed in a cabinet (EIG); the first section is made up of inductive loops (1), weighing sensors (2) and optical cables (CAO); the second is made up of an optical interrogator (3), frequency-to-amplitude transduction equipment (4), information processing and presentation equipment (5) and record printing equipment (6) which can be in the same cabinet as the other components or in another location. With regard to the equipment installed on the pavement (EIP), this is deployed on the road pavement (P) and establishes the measurement region (RM).

According to FIG. 1, the inductive loops (1), which are electrical cables installed in a rectangular, square or circular coil format, are connected unidirectionally to the frequency-to-amplitude transduction equipment (4); The weight sensors (2), whose compositions are discussed in this patent, are connected to the optical interrogator (3) via optical cables (OAC) of the multivia or monovia, single-mode, multimode, photosensitive, bend-insensitive, polarization-maintaining, gradual-profile, microstructured, or similar type and located below the central circle of the deformation profile (PD), parallel to the inductive loops and the frequency-to-amplitude transduction equipment (4); The optical interrogator (3) of the type of edge filter, fabry-perot filter, tunable laser, diffraction grating, or any other capable of carrying out the transduction of the optical wavelength signal, connected unidirectionally to the information processing and presentation equipment (5); frequency-to-amplitude transduction equipment (4), of the Hartley oscillator type or similar, connected unidirectionally to the information processing and presentation equipment (5); and to the weight sensor (2); information processing and presentation equipment (5) of the computer or embedded processor type containing a computer program (SW), connected unidirectionally to the record printing equipment (6), frequency-to-amplitude transduction equipment (4) and to the optical interrogator (3); and record printing equipment (6) of the type of reel, jet or ink tank printer, laser or information printing on an electronic display or program screen and connected unidirectionally to the information processing and presentation equipment (5).

According to FIGS. 4 to 6, the weight sensor (2) is made up of: roughing material (MD) made of metal, plastic, composite or similar rigid material that does not damp the vertical force, wrapped in the damping and protection material (MAP), on the deformation profile (PD) and on the upper part of the weight sensor (2); after installing the weight sensor (2), the roughing material (MD) is sanded to follow the longitudinal profile of the pavement; damping and protection material (MAP) made of polyurethane rubber, silicone, acrylic or another type of cushioning material, surrounding the deformation profile (PD) and the roughing material (MD); protection cover (TP) positioned on the sides of the weight sensor (2); deformation profile (PD) in an “I” shape with a circle in the center and made of metal, plastic or composite material; optical sensor (SO) of the Bragg grating type (FBG), long period grating (LPG) or similar, located in an optical fiber (FO) segment; the optical sensors (OS) are distributed in length and multiplexed in wavelength along the optical fiber (FO) and consequently along the deformation profile (PD); single-mode, multimode, photosensitive, bend-insensitive, polarization-maintaining, gradual-profile, microstructured or similar optical fiber (FO), made of glass, plastic and/or silica, attached to the deformation profile (PD) using cyanoacrylate, epoxy, acrylic or similar glue; before being attached, the optical fiber (FO) and the optical sensor (SO) are pre-stressed.

According to FIG. 7, the weight sensor (2) is installed on the road pavement (P) more specifically in the trench (TR), which has a predetermined trench depth (PT) and trench width (LT) according to the road pavement (P) on which it will be installed, leaving the sensor flush with the pavement and positioned according to the wheels of the cars.

The system in this patent works in the following sequence:

The vehicle passes over the sensor installed in the pavement, exerting an oblique force on the weight sensor (2), which is made up of a roughing material (MD), whose function is to fully transmit the vertical forces exerted by the vehicle wheels to the deformation profile (PD), protected by a damping and protection material (MAP) whose function is to damp horizontal forces coming from the vehicle wheels and the pavement around the sensor, so that the deformation profile (PD) is not deformed by these forces and only by the vertical ones:

The deformation profile (DP) transforms the vertical portion of the oblique force into longitudinal dilations or contractions;

These movements compress or pull the optical sensors (SO), which are present inside a fiber optic section (FO) and are distributed along the deformation profile (PD):

The optical sensors (SO), when pulling or compressing, transduce the horizontal deformation of the deformation profile (DP), varying in wavelength depending on the direction of the effort they receive, this variation being proportional to the vertical effort suffered which is proportional to the weight of the vehicle:

With the variation of wavelengths, multiplexed by the optical fiber (FO), they are transmitted through an optical cable (CAO), to an optical interrogator (3), which reads the signals in wavelength, records it as mathematical data and transfers it to the information processing and display equipment (5); and

Inside the information processing and display equipment (5), a computer program (SW) processes the information obtained by the weight sensors and inductive loops (1) into weight, speed and temperature information, making the information available in printed form (on paper or on a screen) via a record printing equipment (EIR).

The computer program (SW) is part of the information processing and presentation equipment (5), and its procedural sequence is as follows (FIG. 3):
A) Receiving the wavelength variation signal transmitted by the optical interrogator (3);
B) Evaluation of the intensity of the wavelength variation signal; (static or dynamic)
B.1) Greater than the pre-established threshold, proceed to C);
B.2) Less than the pre-established threshold, discarded.
C) Determining the time position of the highest intensity value of the wavelength variation signal;
D) Windowing of the region of interest; (static or dynamic)
E) Integration of the windowed signal, calculating its area;
F) Sum of the areas of the sub-processes e.g. (PSOi, PSO (i+1), PSO ( . . . ), PSO (j−1), PSOj);
G) Weight measurement, to find the weight per wheel (PR), using the sum of the areas of the sub-processes (F), together with the speed value (V) applied in the weight determination function;
H) Add up the weights per wheel (PR) on the same axle, giving the weight per axle (PE);
I) Sum of the weights per axle (PE), in the same axle group, to obtain the weight per axle group (PGE);
J) Sum of the weights per axle group (PGE) within a time period that defines the passage of the vehicle through the measurement region (RM), provided by the presence signal between inductive loops (1), obtaining the total gross weight (PBT); and
K) Presentation of system information (K), made available via a record printing device (EIR).

1. An in-motion weighing system for motor vehicles based on rigid and fiber optic sensors, characterized by a weight sensor (2) consisting of: roughing material (MD) made of metal, plastic, composite or similar rigid material and surrounded by the damping and protection material (MAP), on the deformation profile (PD) and on the upper part of the weight sensor (2); damping and protection material (MAP) made of polyurethane rubber, silicone, acrylic or another type of cushioning material, surrounding the deformation profile (PD) and the roughing material (MD); protection cover (TP) positioned on the sides of the weight sensor (2); deformation profile (PD) in an “I” shape with a circle in the center and made of metal, plastic or composite material; optical sensor (SO) of the Fiber Bragg Grating (FBG), Long Period Grating (LPG) or similar type, located in the optical fiber (FO) segment and distributed along the length of the optical fiber (FO) and consequently along the deformation profile (PD); single-mode, multimode, photosensitive, bend-insensitive, polarization-maintaining, gradual-profile, microstructured, or similar optical fiber (FO), made of glass, plastic and/or silica, attached to the deformation profile (PD) using cyanoacrylate, epoxy, acrylic or similar glue.

2. The in-motion weighing system for motor vehicles based on rigid and fiber optic sensors according to claim 1, characterized by inductive loops (1) of rectangular, square or circular shape, connected unidirectionally to the frequency-to-amplitude transduction equipment (4); the weight sensors (2) are connected to the optical interrogator (3) via optical cables (CAO) of the multivia or monovia, monomode, multimode, photosensitive, bend-insensitive, polarization-maintaining, gradual-profile, microstructured, or similar type and located below the central circle of the deformation profile (PD), parallel to the inductive loops and the frequency-to-amplitude transduction equipment (4); The optical interrogator (3) of the type of edge filter, fabry-perot filter, tunable laser, diffraction grating, or similar, connected unidirectionally to the information processing and presentation equipment (5); frequency-to-amplitude transduction equipment (4), of the Hartley oscillator type or similar, connected unidirectionally to the information processing and presentation equipment (5) and to the weight sensor (2); information processing and presentation equipment (5) of the computer or embedded processor type containing a computer program (SW), connected unidirectionally to the record printing equipment (6), frequency-to-amplitude transduction equipment (4) and to the optical interrogator (3); and record printing equipment (6) of the type of reel, jet or ink tank printer, laser or information printing on an electronic display or program screen and connected unidirectionally to the information processing and presentation equipment (5).

3. An operating process of an in-motion weighing system for motor vehicles based on rigid and fiber optic sensors, characterized by the following sequence of steps:
A) Receiving the wavelength variation signal, transmitted by the optical interrogator (3);
B) Evaluation of the intensity of the wavelength variation signal; (static or dynamic);
B.1) Greater than the pre-established threshold, proceed to C);
B.2) Less than the pre-established threshold, discarded;
C) Determining the time position of the highest intensity value of the wavelength variation signal;
D) Windowing of the region of interest (static or dynamic);
E) Integration of the windowed signal, calculating its area;
F) Sum of the areas of the sub-processes e.g. (PSOi, PSO (i+1), PSO ( . . . ), PSO (j−1), PSOj);
G) Weight measurement, to find the weight per wheel (PR), using the sum of the areas of the sub-processes (F), together with the speed value (V) applied in the weight determination function;
H) Add up the weights per wheel (PR) on the same axle, giving the weight per axle (PE);
I) Sum of the weights per axle (PE), in the same axle group, to obtain the weight per axle group (PGE);
J) Sum of the weights per axle group (PGE) within a time period that defines the passage of the vehicle through the measurement region (RM), provided by the presence signal between inductive loops (1), obtaining the total gross weight (PBT); and
K) Presentation of system information (K), made available via a record printing device (EIR).

4. The operating process of the in-motion weighing system for motor vehicles based on rigid and fiber optic sensors, according to claim 3, characterized by transformation of the data collected by the weight sensors (2), of the present patent, in the following sequence:
1) The vehicle passes over the sensor installed in the sidewalk exerting an oblique force on the weight sensor (2), on the roughing material (MD) fully transmitting the forces exerted by the vehicle wheels to the deformation profile (PD), with damping and protection material (MAP) damping horizontal forces, coming from the vehicle wheels and the sidewalk around the sensor, so that the deformation profile (PD) is not deformed by such forces and only by the vertical ones;
2) The deformation profile (DP) transforms the vertical portion of the oblique force into longitudinal dilations or contractions;
3) These movements compress or pull the optical sensors (SO), which are present inside a fiber optic section (FO) and are distributed along the deformation profile (PD);
4) The optical sensors (SO), when pulling or compressing, transduce the horizontal deformation of the deformation profile (DP), varying in wavelength depending on the direction of the effort they receive, this variation being proportional to the vertical effort suffered which is proportional to the weight of the vehicle;
5) With the variation of wavelengths, multiplexed by the optical fiber (FO), they are transmitted through an optical cable (CAO), to an optical interrogator (3), which reads the signals in wavelength, records it as mathematical data and transfers it to the information processing and presentation equipment (5); and
6) Inside the information processing and presentation equipment (5), a computer program (SW) processes the information obtained by the weight sensors and inductive loops (1) into weight, speed and temperature information, making the information available in printed form (on paper or on a screen) via a record printing equipment (EIR).
